(19) United States
(12) Patent Application Publication
(10) Pub. No.: US 2013/0006692 A1
(43) Pub. Date: Jan. 3, 2013

(54) SYSTEMS AND METHODS FOR REAL TIME TRANSFORMATION OF RETAIL BANK BRANCH OPERATIONS

(75) Inventors: Sandeep Hans, Haifa (IL); Sameep Mehta, New Delhi (IN); Gyana Ranjan Parija, Haryana (IN); Pimplikar Rakesh Rameshrao, Nagpur (IN)

(73) Assignee: INTERNATIONAL BUSINESS MACHINES CORPORATION, Armonk, NY (US)

(21) Appl. No.: 13/170,499

(22) Filed: Jun. 28, 2011

(51) Int. Cl. G06Q 10/00; G06Q 50/00

(52) U.S. Cl. 705/7.22; 705/7.24

(57) ABSTRACT

Methods and arrangements for generating process recommendations. Customer information is assimilated, the customer information including a number of present customers. An efficiency matrix is assimilated, which indicates efficiency for each of a plurality of actual resources with respect to each of a plurality of services. At least one hypothetical resource is created, which incorporates a best efficiency from among the actual resources with respect to each of the plurality of services, and a scheduling policy is assimilated. A customer queue is generated with respect to each hypothetical resource and in accordance with the at least one scheduling policy. Each hypothetical resource is mapped to each actual resource and a minimum parameter increase from among pairs comprising a hypothetical resource and an actual resource is determined.

### BACKGROUND

Generally, customers in many developing countries prefer to visit bank branches for their banking needs. Even though various alternatives such as ATM's (automatic teller machines), Internet banking and mobile banking have evolved significantly in the last few years, the bank branch has still retained its position as the primary service delivery channel in many emerging economies. Due to various factors such as literacy, lacking infrastructure, the legacy of public sector banks, and lack of trust in e-transactions, the alternatives have not been adopted widely.

Using India as an example, while private banks there see nearly 35 to 40% of their transactions in the aforementioned alternative channels, this figure is in the single digits for public sector banks, where the vast majority of the population still banks. This results in high footfall in the bank, which makes it difficult to maintain customer satisfaction (CSAT) at an acceptable level. Retail banking, indeed, represents an industry in which CSAT plays a key role in the retention and growth of a customer base.

It has been found that factors such as wait time, staff interaction, service time, and information availability strongly influence CSAT, with wait time being particularly significant. Moreover, due to huge customer volume, service personnel end up being under near-constant scrutiny by customers and often face tremendous pressure, often unwarranted, to work more efficiently. There can easily be noted a causal relationship between ESAT (employee satisfaction) and CSAT. For example, less pressure on employees will reflect itself in better interaction with customers, which in turn will positively impact CSAT.

A seemingly straightforward solution to the above mentioned challenges is to increase the number of service personnel. This will reduce wait time of customers (thereby increasing CSAT) as well as reduce workload for the service personnel (thereby influencing ESAT). However, the mere addition of personnel often emerges as an unviable solution because the bank has to incur costs for hiring, training, providing seats, procuring computers etc.

### BRIEF SUMMARY

In summary, one aspect of the invention provides a method comprising: assimilating customer information, the customer information including a number of present customers; assimilating an efficiency matrix which indicates efficiency for each of a plurality of actual resources with respect to each of a plurality of services; creating at least one hypothetical resource which incorporates a best efficiency from among the actual resources with respect to each of the plurality of services; assimilating a scheduling policy; generating a customer queue with respect to each hypothetical resource and in accordance with the at least one scheduling policy; and mapping each hypothetical resource to each actual resource and determining a minimum parameter increase from among pairs comprising a hypothetical resource and an actual resource.

Another aspect of the invention provides an apparatus comprising: at least one processor; and a computer readable storage medium having computer readable program code embodied therewith and executable by the at least one processor, the computer readable program code comprising: computer readable program code configured to assimilate customer information, the customer information including a number of present customers; computer readable program code configured to assimilate an efficiency matrix which indicates efficiency for each of a plurality of actual resources with respect to each of a plurality of services; computer readable program code configured to create at least one hypothetical resource which incorporates a best efficiency from among the actual resources with respect to each of the plurality of services; computer readable program code configured to assimilate a scheduling policy; computer readable program code configured to generate a customer queue with respect to each hypothetical resource and in accordance with the at least one scheduling policy; and computer readable program code configured to map each hypothetical resource to each actual resource and determine a minimum parameter increase from among pairs comprising a hypothetical resource and an actual resource.

An additional aspect of the invention provides a computer program product comprising: a computer readable storage medium having computer readable program code embodied therewith, the computer readable program code comprising: computer readable program code configured to assimilate customer information, the customer information including a number of present customers; computer readable program code configured to assimilate an efficiency matrix which indicates efficiency for each of a plurality of actual resources with respect to each of a plurality of services; computer readable program code configured to create at least one hypothetical resource which incorporates a best efficiency from among the actual resources with respect to each of the plurality of services; computer readable program code configured to assimilate a scheduling policy; computer readable program code configured to generate a customer queue with respect to each hypothetical resource and in accordance with the at least one scheduling policy; and computer readable program code configured to map each hypothetical resource to each actual resource and determine a minimum parameter increase from among pairs comprising a hypothetical resource and an actual resource.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a computer system.

FIG. 2 schematically illustrates a front-end banking environment.

FIG. 3 schematically illustrates a process of applying an algorithm to generate recommendations.

FIG. 4 sets forth a process more generally for generating process recommendations.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art will recognize, however, that the various embodiments of the invention can be practiced without at least one of the specific details, or with other methods, components, materials, et cetera. In other instances, well-known structures, materials, or operations are not shown or described in detail to avoid obscuring aspects of the invention.

The description now turns to the figures. The illustrated embodiments of the invention will be best understood by reference to the figures. The following description is intended only by way of example and simply illustrates certain selected exemplary embodiments of the invention as claimed herein.

It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

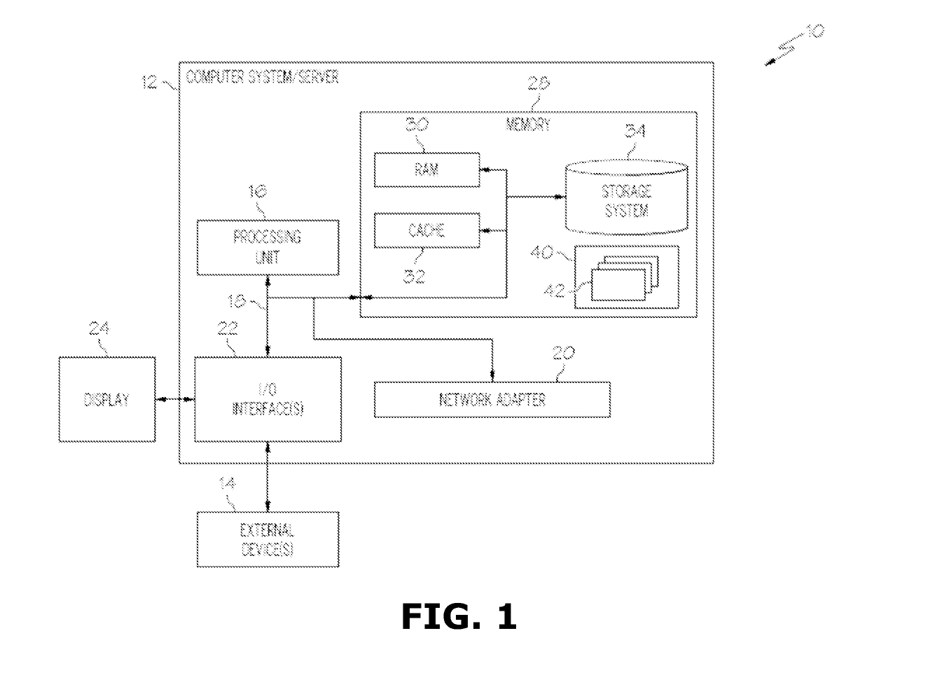

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove. In accordance with embodiments of the invention, computing node 10 may not necessarily even be part of a cloud network but instead could be part of another type of distributed or other network, or could represent a stand-alone node. For the purposes of discussion and illustration, however, node 10 is variously referred to herein as a “cloud computing node”.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, at least one processor or processing unit 16, a system memory 28, and a bus 18 that couples various system components including system memory 28 to processor 16.

Bus 18 represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by at least one data media interface. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, at least one application program, other program modules, and program data. Each of the operating system, at least one application program, other program modules, and program data or some combination thereof, may include an implementation of a networking environment. Program modules 42 generally carry out the functions and/or methodologies of embodiments of the invention as described herein.

Computer system/server 12 may also communicate with at least one external device 14 such as a keyboard, a pointing device, a display 24, etc.; at least one device that enable a user to interact with computer system/server 12; and/or any devices (e.g., network card, modem, etc.) that enable computer system/server 12 to communicate with at least one other computing device. Such communication can occur via I/O interfaces 22. Still yet, computer system/server 12 can communicate with at least one network such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

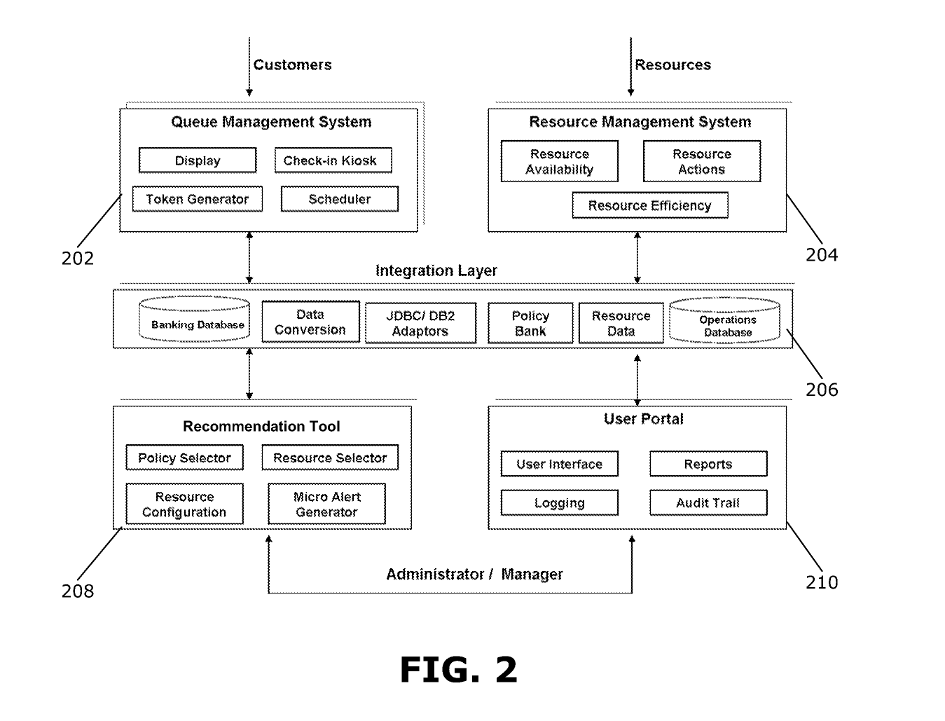

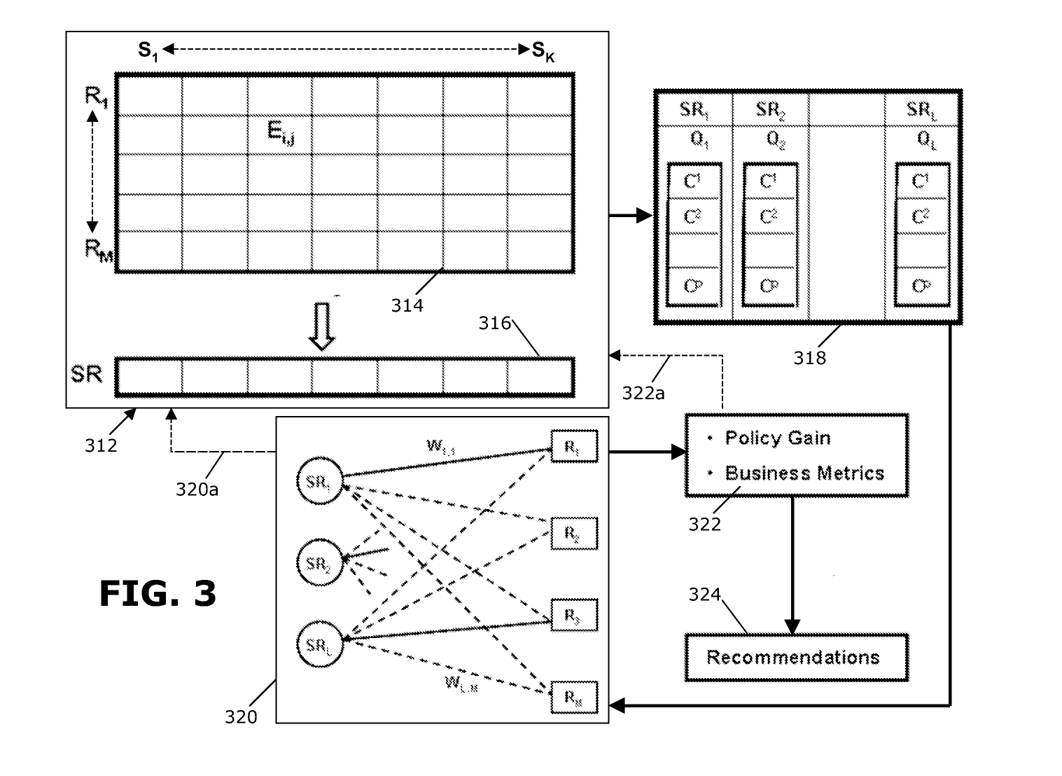

The disclosure now turns to FIGS. 2 and 3. It should be appreciated that the processes, arrangements and products broadly illustrated therein can be carried out on or in accordance with essentially any suitable computer system or set of computer systems, which may, by way of an illustrative and non-restrictive example, include a system or server such as that indicated at 12 in FIG. 1. In accordance with an example embodiment, most if not all of the process steps, components and outputs discussed with respect to FIGS. 2 and 3 can be performed or utilized by way of a processing unit or units and system memory such as those indicated, respectively, at 16 and 28 in FIG. 1, whether on a server computer, a client computer, a node computer in a distributed network, or any combination thereof.

In accordance with at least one embodiment of the present invention, there is broadly contemplated herein a “recommendation tool” for retail bank branch reconfiguration which, essentially, serves to generate recommendations for an administrator or branch manager to reconfigure operations. It should be noted that the discussion herethroughout, while focusing on retail banking by way of illustrative example, need not be taken as restrictive. Particularly, the processes and arrangements broadly contemplated and described herein may be applicable to a very wide range of analogous settings, such as other retail settings or other instances in which queue management and resource management are to be reconciled with one another.

In accordance with at least one embodiment of the invention, the recommendation tool generates recommendations to answer different questions given a real time mix of customers, service requests and resources. (Herethroughout the terms “resources”, “personnel”, “employees” and “service personnel” are used interchangeably and refer to essentially the same entity.) A first question would address what involves a good or workable scheduling policy, where policy efficacy is reconciled with respect to business metrics. A second question would address how many resources should be employed; a correct supply of resources will aid in matching customer demand. Another question would address what the configuration of resources should be. In other words, since different people (resources) display different proficiency towards different services, Therefore the most efficient resources should be chosen relative to particular service requests, and for this historical efficiency data of resources can be used.

FIG. 2 provides a high level view of different components employed in front end banking activities, as an illustrative (and non-restrictive) example of environment for at least one embodiment of the invention. As shown, a queue management system 202 and resource management system 204 are included with respect to customers and resources, respectively. A queue management system 202, or QMS, includes customer check-in through a touch screen kiosk or ATM card swipe, generating & dispensing the token number, scheduling the customers as per the policy recommended by the recommendation tool and displaying the token numbers on display which may be accompanied by a voice announcement. A resource management system 204, or RMS, on the other hand, includes functionalities for logging a resource into the system (for attendance tracking), keeping track of breaks and assessing resource availability (which in turn is used by the QMS 202 to assign customers to resources). The efficiency of every resource is also computed and stored via RMS 204; this can be determined, e.g., as the average service time of a resource with respect to a given service type.

In accordance with at least one embodiment of the invention, a user portal 210 is embodied as a standard web based portal where the user can log-in to generate and view management reports. On the other hand, integration layer 206 essentially serves as a “glue” to hold other components together seamlessly. For instance, integration layer 206 includes adapters to permit the functionality of individual components. For instance, a data conversion module transforms data into formats understandable by different units while the banking database stores account and customer related information. The operational database stores diverse day to day data, e.g., customer arrival time, requested services, customer category, customer call-in time, customer exit time, etc. This information can be used by the QMS 202 to schedule customers and by user portal 210 for reports. The policy bank provides various scheduling policies which can be used to rank and serve customers. Finally, efficiency data of individual resources is made accessible by this layer (206).

In accordance with at least one embodiment of the invention, a recommendation tool 208 leverages information from the integration layer 206 and elsewhere to generate recommendations. In one functionality, recommendation tool 208 serves to select a scheduling policy. Typically, banks use FIFO (first in, first out) policy to provide service to customers. Using FIFO, banks are unable to differentiate among customers and cannot provide better service experience (e.g., by reducing wait time) of important customers or customers requesting profitable services. For instance, in a setting with 20 waiting customers, a first scenario might see two out of the 20 as being particularly important. Thus, in this case a non-FIFO policy which reduces wait time of the important customers by pushing them ahead in queue is a good alternative. In a second scenario, however, 15 out of the 20 might be considered more important customers. In this case, FIFO may be the best policy because pushing important customers ahead will result in a long wait time for the other five customers, which will result in negative CSAT.

In accordance with at least one embodiment of the invention, another functionality of the recommendation tool 206 is to determine the number and configuration of resources. As such, it can be noted that the efficiency of human resources varies with respect to service type. It is entirely possible for a resource to be most efficient in providing service S₁ while being the slowest for service S₂. Therefore, it is important to consider the individual efficiency of resources and the current customer and to identify a “correct” set of resources. The “correct” set of resources may provide better service quality than a larger set of “incorrect” resources.

In accordance with at least one embodiment of the invention, the recommendation tool 208 is configured to generate recommendations at set intervals, e.g., once every 30 minutes. It can be noted that more frequent intervals may result in more frequent changes of resources, thereby engendering confusion and inconvenience for customers and resources alike.

The disclosure now turns to an algorithm which may be employed by a recommendation tool in accordance with at least one embodiment of the invention, via a process as set forth in FIG. 3. Accordingly, let [symbol] ={C₁, C₂, . . . , C_{N}} denote the customers, with [symbol] ={S₁, S₂, . . . , S_{K}} being the list of services offered by the organization (e.g., bank) in question. Each customer Cᵢ is associated with an arrival time ATᵢ, service request(s) Gᵢ ⊂S and a data packet Dᵢ. The data packet can contain customer specific information such category, number of years with the bank, average quarterly balance, etc. The customer information that can be used is wide and varied, and can be configured most suitably for the setting at hand or in accordance with specific policies desired by the organization in question. For example, a policy can give more priority to customers with long-running accounts. This priority can be calculated by using the data packet.

In accordance with at least one embodiment of the invention, the list of scheduling policies are represented by [symbol] ={P₁, P₂, . . . , P_{Q}}. The list of M resources is denoted by [symbol] ={R₁, R₂, . . . , R_{M}}. E is a M×K matrix capturing the efficiency of resources. E_{i,j} stores the time which Rᵢ takes to serve a request of type Sⱼ. Finally, [symbol] ={B₁, B₂, . . . , B_{U}} represents the list of business metrics. Each policy Pᵢ will generate a schedule for serving customers and also evaluate the generated schedule with respect to various business metrics. Such metrics can include, but need not necessarily be limited to, parameters such as wait time, wait time per category, wait time of important customers, wait time of customers with profitable services, etc.

In accordance with at least one embodiment of the invention, a policy evaluation function generates a schedule Sch_{P}_{ᵢ} using policy Pᵢ, subset of customers C′, subset of resources R′ and corresponding efficiency metric E′. The definition is: Sch=evalPolicy (Pᵢ, C′,R′, E′). If there are L resources, the schedule will have L ranked lists, one corresponding to each resource. As will be appreciated with steps 312 and 318 in FIG. 3, this function is illustratively employed herein with respect to equally efficient resources; thus, scheduling reduces to a single resource scheduling problem (solvable in polynomial time) and a schedule generation component simply picks and unserved customer from a ranked list and assigns it to a free resource, thereby creating L ranked lists for L resources.

In accordance with at least one embodiment of the invention, a schedule evaluation function, given a schedule generated by Pₖ, returns values of different business metrics. The definition is B=evalSch (Sch_{P}_{ₖ}, R′,E′). For each resource, the corresponding ranked list is simulated by taking into account the efficiency of the resource.

In accordance with at least one embodiment of the invention, a gain evaluation function, given a schedule and two policies P₁ & P₂, computes the difference in the value of different business metrics. A currently configured policy is regarded as a baseline. Therefore, the difference in business metrics can be construed as gain [symbol] which a candidate policy P₂ realizes over the current in-use policy P₁. The function is implemented as:

$${∀}_{i = 1}^{U} G ( i ) = \frac{{B}_{i}^{{P}_{2}} - {B}_{i}^{{P}_{1}}}{{B}_{i}^{{P}_{1}}}$$

It should be noted that conventionally, the problem of scheduling customers on unrelated machines with known number of resources is a NP-complete problem. Our problem becomes much harder because the number of machines (resources) and which resources to be used are also unknown. The choice of resources depend upon the job characteristics. Moreover, due to complexity of problem arising from varying efficiency of resources, properties which could help to reduce search space does not hold. For example, P₁ can outperform P₂ on a business metric given L resources, however, with addition of one more resource, the performance may be reversed. Similarly, given customer and service data, assume we use a single resource to serve all customers. Let resource R₁ be the best performer followed by R₂ and R₃. However, the top resources together, i.e., {R₁, R₂} can be outperformed by combination of {R₂, R₃}. This can happen if efficiency of R₂ and R₃ complement each other.

In accordance with at least one embodiment of the invention, referring now to FIG. 3, in a first process step 312, for each service type Sⱼ, there is found from efficiency matrix 314 the resource Rᵢ which takes the least time to provide the service and. The corresponding service time E_{i,j} is stored in a “super resource” (SR) matrix 316. Formally, SRⱼ=min {E*ⱼ}, while SR can be conceived as a “super resource” which provides all services in minimum time possible. In other words, the “super resource” can be considered to be an aggregation of one or more individual resources best configured to handle individual tasks, or a hypothetical “super” individual that combines all the best attributes from among individual resources.

In a second process step 318, in accordance with at least one embodiment of the invention, a schedule is generated given a scheduling policy PₖεP and L resources where 1≦L≦M. The assumption here is that all L resources are considered to be “super resources”, and a hypothetical queue is generated with respect to each resource L. Moreover, evalPolicy can be employed here to generate a schedule. This construction provides, hypothetically, the best performance (in terms of average wait time) which can be achieved by L resources. To the extent that L queues are being developed in this process step (318), then, the super resource matrix 316, or at least information therefrom, can be understood as being copied here L times.

In a third process step 320, in accordance with at least one embodiment of the invention, super resources are mapped to actual resources (as shown here via a bipartite graph) while incurring an increase in wait time. For a resource SRᵢ and Policy Pₖ, the average wait time WT_{SR}_{ᵢ}^{P}^{ₖ} of assigned customers (Qᵢ in step 318) as per policy Pₖ is computed by using evalSch. In other words, in step 320, L super resources are mapped to L actual resources while minimizing the increase in wait time. This problem is posed as a maximum bipartite matching with weights. “Super resources” (SR) form one set of vertices while actual resources (R) the other set. The graph is fully connected because every super resource can be replaced by any of the actual resources. The cost of replacing a super resource by actual resource is then determined as C_{i,j}=WT_{R}_{ⱼ}^{P}^{ₖ}−WT_{SR}_{ᵢ}^{P}^{ₖ}, wherein a resulting cost/penalty captures the increase in wait time if SRᵢ is replaced by Rⱼ. Since an objective is to find maximum weight matching, the weights are computed as W_{i,j}=max(C*,*)−C_{i,j}+1. Such matching can be undertaken by a suitable conventional algorithm, such as disclosed in Galil, Z., “Efficient algorithms for finding maximum matching in graphs,” ACM Computing Surveys 18(1):23, 1986. That algorithm takes O(mnlog_{[m/n+1]}n), where n is the number of nodes and m is the number of edges.

In accordance with at least one embodiment of the invention, steps 318 and 320 are iteratively repeated (320a) by keeping the resources fixed at L and changing the policy. At the end of these iterations, there will be identified L best resources for each Pₖ.

In a fourth process step 322, in accordance with at least one embodiment of the invention, the gain [symbol] and other business metrics are computed for each policy, and a rule-based system is used to generate candidate recommendations. In accordance with a first rule, the Gain ( [symbol] ) over the current configuration should be greater than θ₁, where θ₁ defines the improvement which the organization would like to witness. All policies with corresponding gain greater than θ₁ arechosen to generate candidate recommendation. By way of an illustrative and non-restrictive example, the average wait time of all customers is used to compute gain. If the gain is not significant, it implies that the organization is exchanging a business process with a new one without substantial improvements in play. In accordance with a second rule, given a policy (selected by the first rule) and a set of resources, a computation is made of how many customers can be served in the next F minutes (e.g., interval at which the recommendation tool is already set to generate new recommendations). Subtracting this from the total waiting customers C′ (used in algorithmic policy evaluation as discussed hereinabove) will yield the number of unserved customers UC at the end of F minutes. If

$$\frac{UC}{{C}^{′}} \leq {θ}_{2} ,$$

then the configuration gets designated as a candidate recommendation.

Accordingly, in accordance with at least one embodiment of the invention, the configurations which satisfy both rules are tagged as a candidate recommendations with the following details:

$$\{ {P}_{k} , {C}^{′} , L , {R}^{′} , {E}^{′} , , \frac{UC}{{C}^{′}} \} .$$

If no configuration satisfies the aforementioned rules, then number of resources is increased by 1 (iteration 322a) and step 318 is repeated. This iterative process is continued till L reaches M.

In a fifth process step 324, in accordance with at least one embodiment of the invention, the candidate recommendations are presented to the administrator to choose from. The chosen recommendation then replaces the current configuration and is used for the next F minutes. In other words, the process of FIG. 3 can act to provide a policy and resource assignment recommendation at user-defined intervals, such as once every F minutes, where F can be a convenient value such as 30. In a variant embodiment, a recommendation can be chosen automatically based on quantitative data; however, an additional “manual” step of choosing from a set of candidate recommendations can allow qualitative factors into the determination, as may be observed by the administrator. For instance, the administrator can investigate respective policies and conclude that the policy used in a CR₂ enforces fairness whereas CR₁ gives high preference to a set of customers. In this case, based on business logic and other real time factors, he or she may decide to choose CR₂.

In accordance with at least one variant embodiment of the invention, a manager can be apprised of information dynamically so as to be in a position to take ad-hoc action as needed, concurrent with or in addition to a general process such as that shown in FIG. 3. Such dynamically available information can include, but not be limited to: customers who have been waiting an inordinately long time, drilled down by parameters such as service type, customer mix and customer value; slowly working resources, drilled down by service type, which in turn may provide insights into training needs; overall branch or location performance, characterized by customer wait time and drilled down by service type and customer type; and resource productivity.

In accordance with at least one variant embodiment of the invention, the manager can take action of his or her own accord based on dynamically acquired information such as that discussed hereinabove. Accordingly, he or she may then opt to re-run the recommendation tool and fine-tune operations by changing at least one of: policy; the number of resources; and resource configuration.

In accordance with at least one variant embodiment of the invention, a counter (or location where a resource serves customers) can be dedicated to one and only one service if a sufficient proportion of customers are requesting the service. A dedicated counter can be designated if, the number of customers requesting that service multiplied by the average time to conduct the service per customer is greater than or equal to the predetermined interval F for generating new recommendations. Thus, a reasonable assurance would be made that the counter or location in question would be dedicated solely to the one service at least through the current recommendation interval. If a counter or location indeed is so dedicated, the process can be configured to assign a spare resource to the dedicated location, or close another counter and reassign the associated resource to the dedicated location. If any reallocation of spare or current resources might be determined to unreasonably compromise other services being given to other customers, then such a consideration could override criteria that otherwise would justify opening a dedicated location.

In accordance with at least one variant embodiment of the invention, a recommendation tool can collect and analyze real time data to generate alerts. Such alerts can include, but not be limited to: a resource is serving fewer or more customers than expected or originally allocated, where low quality or an overly small queue, for example, can be discerned; one or a small number of customers are waiting for a long time; a particular transaction is taking an inordinately long time with one resource. As such, real time triggers can be provided to develop a new or revised recommendation prior to the end of the current interval. Such triggers can include, but need not be limited to: significant deviation in the distribution of customers (predicted vs. actual); a change in the number of resources (e.g., due to an emergency that compels one or more resources to vacate their positions); a significant deviation in the distribution of service; core platform downtime; and a significant deviation in the expected wait time of customers.

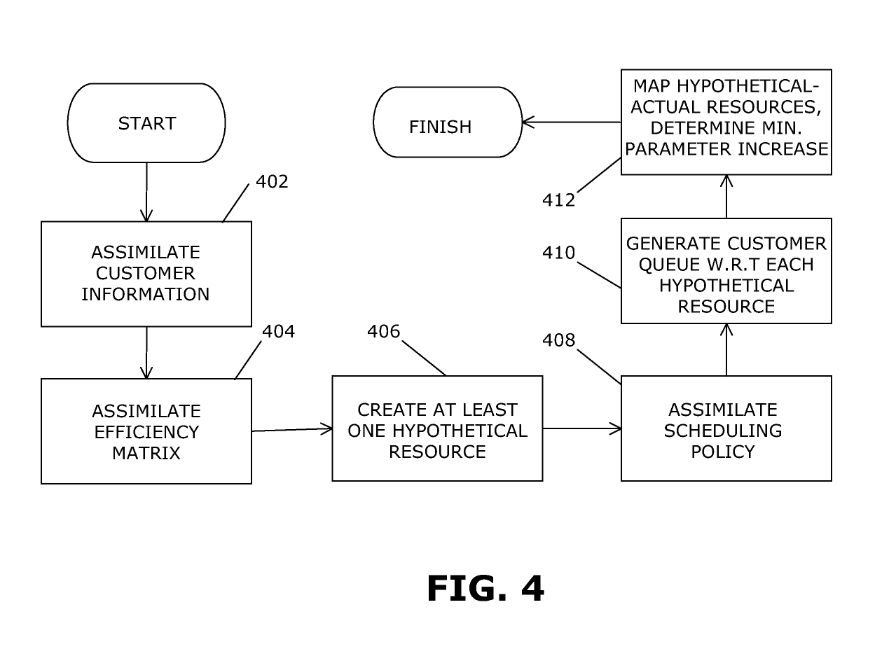

FIG. 4 sets forth a process more generally for generating process recommendations, in accordance with at least one embodiment of the invention. It should be appreciated that a process such as that broadly illustrated in FIG. 4 can be carried out on essentially any suitable computer system or set of computer systems, which may, by way of an illustrative and on-restrictive example, include a system such as that indicated at 12 in FIG. 1. In accordance with an example embodiment, most if not all of the process steps discussed with respect to FIG. 4 can be performed by way a processing unit or units and system memory such as those indicated, respectively, at 16 and 28 in FIG. 1.

As shown in FIG. 4, customer information is assimilated (402), the customer information including a number of present customers. An efficiency matrix is assimilated (404), which indicates efficiency for each of a plurality of actual resources with respect to each of a plurality of services. At least one hypothetical resource is created (406), which incorporates a best efficiency from among the actual resources with respect to each of the plurality of services, and a scheduling policy is assimilated (408). A customer queue is generated (410) with respect to each hypothetical resource and in accordance with the at least one scheduling policy. Each hypothetical resource is mapped to each actual resource and a minimum parameter increase from among pairs comprising a hypothetical resource and an actual resource is determined (412).

It should be noted that aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in at least one computer readable medium having computer readable program code embodied thereon.

Any combination of at least one computer readable medium may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having at least one wire, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the invention may be written in any combination of at least one programming language, including an object oriented programming language such as Java®, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

1. A method executed by a processor, comprising:
assimilating customer information, the customer information including a number of present customers;
assimilating an efficiency matrix which indicates efficiency for each of a plurality of actual resources with respect to each of a plurality of services;
creating, from the efficiency matrix, at least one hypothetical resource which incorporates and aggregates a best efficiency from among the actual resources with respect to each of the plurality of services;
assimilating a scheduling policy;
generating a customer queue with respect to the at least one scheduling policy; and
said generating comprising:
mapping each hypothetical resource to each actual resource and determining a minimum parameter increase from among pairs comprising a hypothetical resource and an actual resource; and
reconciling the minimum parameter increase with the at least one scheduling policy to determine the customer queue.

2. The method according to claim 1, further comprising:
selecting a best resource based on the determined minimum parameter increase;
ascertaining a gain represented by the assimilated scheduling policy with respect to a current scheduling policy.

3. The method according to claim 1, further comprising repeating said assimilating of a scheduling policy, generating and mapping and determining with respect to each of at least one additional scheduling policy.

4. The method according to claim 1, further comprising seeking to filter at least one candidate recommendation from a plurality of resource scheduling recommendations, the plurality of resource scheduling recommendations corresponding to each of the scheduling policies.

5. The method according to claim 4, wherein said seeking to filter comprises designating a resource scheduling recommendation as a candidate recommendation upon a gain at least meeting a predetermined threshold.

6. The method according to claim 4, wherein said seeking to filter comprises designating a resource scheduling recommendation as a candidate recommendation upon a projected number of customers over a predetermined time period, with respect to total waiting customers, being less than or equal to a predetermined ceiling.

7. The method according to claim 4, wherein said seeking to filter comprises iteratively increasing a number of available resources in the event of no candidate recommendations being filtered, and thereupon reverting to said steps of assimilating a scheduling policy, generating and mapping and determining.

8. The method according to claim 1, wherein efficiency relates to time for a resource to undertake a service.

9. The method according to claim 1, wherein parameter increase relates to a prospective increase in average customer wait time.

10. The method according to claim 1, further comprising dynamically providing real time information to prompt possible manual or automatic process intervention.

11. (canceled)

12. The method according to claim 1, further comprising assigning a resource to a location to provide a single dedicated service responsive to customer demand for the single dedicated service.

13. An apparatus comprising:
at least one processor; and
a computer readable storage medium having computer readable program code embodied therewith and executable by the at least one processor, the computer readable program code comprising:
computer readable program code configured to assimilate customer information, the customer information including a number of present customers;
computer readable program code configured to assimilate an efficiency matrix which indicates efficiency for each of a plurality of actual resources with respect to each of a plurality of services;
computer readable program code configured to create, from the efficiency matrix, at least one hypothetical resource which incorporates and aggregates a best efficiency from among the actual resources with respect to each of the plurality of services;
computer readable program code configured to assimilate a scheduling policy;
computer readable program code configured to generate a customer queue in accordance with the at least one scheduling policy, via:
mapping each hypothetical resource to each actual resource and determine a minimum parameter increase from among pairs comprising a hypothetical resource and an actual resource; and
reconciling the minimum parameter increase with the at least one scheduling policy to determine the customer queue.

14. A computer program product comprising:
a computer readable storage medium having computer readable program code embodied therewith, the computer readable program code comprising:
computer readable program code configured to assimilate customer information, the customer information including a number of present customers;
computer readable program code configured to assimilate an efficiency matrix which indicates efficiency for each of a plurality of actual resources with respect to each of a plurality of services;
computer readable program code configured to create, from the efficiency matrix, at least one hypothetical resource which incorporates and aggregates a best efficiency from among the actual resources with respect to each of the plurality of services;
computer readable program code configured to assimilate a scheduling policy;
computer readable program code configured to generate a customer queue in accordance with the at least one scheduling policy, via:
mapping each hypothetical resource to each actual resource and determine a minimum parameter increase from among pairs comprising a hypothetical resource and an actual resource; and
reconciling the minimum parameter increase with the at least one scheduling policy to determine the customer queue.

15. The computer program product according to claim 14, wherein said computer readable program code is further configured to:
select a best resource based on the determined minimum parameter increase; and
ascertain a gain represented by the assimilated scheduling policy with respect to a current scheduling policy.

16. The computer program product according to claim 14, said computer readable program code is configured to repeat assimilating a scheduling policy, generating and mapping and determining with respect to each of at least one additional scheduling policy.

17. The computer program product according to claim 14, wherein said computer readable program code is further configured to seek to filter at least one candidate recommendation from a plurality of resource scheduling recommendations, the plurality of resource scheduling recommendations corresponding to each of the scheduling policies.

18. The computer program product according to claim 17, wherein said computer readable program code is configured to designate a resource scheduling recommendation as a candidate recommendation upon a gain at least meeting a predetermined threshold.

19. The computer program product according to claim 17, wherein said computer readable program code is configured to designate a resource scheduling recommendation as a candidate recommendation upon a projected number of customers over a predetermined time period, with respect to total waiting customers, being less than or equal to a predetermined ceiling.

20. The computer program product according to claim 17, wherein said computer readable program code is configured to iteratively increase a number of available resources in the event of no candidate recommendations being filtered, and thereupon reverting to said steps of assimilating a scheduling policy, generating and mapping and determining.

21. The computer program product according to claim 14, wherein efficiency relates to time for a resource to undertake a service.

22. The computer program product according to claim 14, wherein parameter increase relates to a prospective increase in average customer wait time.

23. The computer program product according to claim 14, wherein said computer readable program code is further configured to dynamically provide real time information to prompt possible manual process intervention.

24. The computer program product according to claim 14, wherein said computer readable program code is further configured to dynamically provide real time information to prompt possible automatic process intervention.

25. The computer program product according to claim 14 wherein said computer readable program code is further configured to assign a resource to a location to provide a single dedicated service responsive to customer demand for the single dedicated service.

26. The method according to claim 1, wherein said creating of at least one hypothetical resource comprises deriving a reduced matrix relative to resources and services, the reduced matrix incorporating best efficiencies, relative to resources and services, from the efficiency matrix.
